(19) United States
(12) Patent Application Publication
(10) Pub. No.: US 2008/0308744 A1
(43) Pub. Date: Dec. 18, 2008

(54) Serum Albumin Conjugated to Fluorescent Substances for Imaging

(75) Inventors: John V. Frangioni, Wayland, MA (US); Shunsuke Onishi, Osaka (JP)

Correspondence Address: ROPES & GRAY LLP, PATENT DOCKETING 39/41, ONE INTERNATIONAL PLACE, BOSTON, MA, 02110-2624, US

(73) Assignee: Beth Israel Deaconess Medical Center, Boston, MA (US)

(21) Appl. No.: 10/579,613

(22) PCT Filed: Nov. 17, 2004
(86) PCT No.: PCT/US04/38682

§ 371 Date: Jul. 14, 2008

(30) Foreign Application Priority Data
Nov. 18, 2003 (US) 60523059
Sep. 9, 2004 (US) 60608267

(51) Int. Cl. G01J 1/58

(52) U.S. Cl. 250/458.1; 250/459.1

(57) ABSTRACT

Compositions and methods are disclosed for imaging tissue or a lymphatic or circulatory system, for example, in the near infrared. Dyes that emit wavelengths in the infrared or near infrared regions of the spectrum may be employed on their own, as combinations or complexed with serum albumin, or as part of a covalent conjugate with serum albumin.

### FEDERALLY SPONSORED RESEARCH OR DEVELOPMENT

The U.S. Government may have certain rights in this invention pursuant to Contract Nos. DMR-9808941 and DMR-0213282 by the Office of Naval Research, and Contract Nos. DE-FG02-01ER63188 and NIH R21EB-00673 by the Department of Energy.

### BACKGROUND

Imaging the living tissues of a patient has become an important tool in the diagnosis and treatment of innumerable disorders and conditions. Imaging bodily fluids, such as lymph and blood, can readily be performed by injecting a detectable substance into the fluid of interest, but existing methods have drawbacks. For example, many common imaging agents quickly degrade in the body, and are only useful for imaging for a short period of time. Other longer-lasting agents are toxic and therefore not suited to use at high dosages or over long periods of time. Accordingly, imaging agents are needed that permit imaging of fluid systems over an extended period of time without incurring significant toxic reactions in the patient.

### SUMMARY

In general, the subject compositions, comprising a serum albumin protein conjugated to one or more detectable moieties such as fluorescent moieties, can be used to map the vasculature and/or lymphatic system of a patient.

Mapping of the lymphatic system can include real-time mapping of sentinel lymph nodes (SLN). In conjunction with the intraoperative NIR fluorescence imaging system, near infrared (NIR) and infrared (IR) emission from the subject compositions can be used to provide a surgeon with light-based, sensitive, specific, and real-time mapping of sentinel lymph nodes. The compositions, in combination with an intraoperative NIR emission imaging system, can provide SLN mapping for all types of human solid cancers, especially melanoma and breast cancer.

Traditionally, intraoperative sentinel lymph node (SLN) mapping for melanoma and breast cancer is performed using a combination of radioactive tracers and blue dyes. Radioactive tracers, such as Technetium-99m sulfur colloid, emits mid-energy (140 keV) gamma rays within the body. Isosulfan blue, a blue dye (trade name Lymphazurin™), is used at a concentration of about 17 mM to locate the SLN. The blue dye requires surgical exploration to find the lymph node. Advantageously, the subject compositions can be monitored through the skin to identify the sentinel node, avoiding or minimizing surgical exploration. In addition, this light-based approach can replace or supplement radioactivity and blue dye tracing, can permit imaging of lymph node flow in real-time, not just approximate positions given by radioactive tracers, and, because NIR and IR light is used, can permit even deep lymph nodes to be mapped. The compositions are excited by light and emit light, thereby replacing the need to produce images using X-ray technology.

In one aspect, a method of imaging a lymphatic system of an animal includes introducing a composition subcutaneously or intraparenchymally in the mammal, the composition including a dye as disclosed herein, and detecting emission from the dye. The composition can be introduced peri-tumoral in the animal. Detecting emission can include generating an image in the near-infrared or infrared wavelength region. The method can include generating a composite image including a real-time image of an area surrounding the injection site and the image in the near-infrared or infrared wavelength region. The method can include exposing the animal to white light (especially where quantum dots are used) or light comprising at least an excitation wavelength for the dye being used. Detecting emission can include monitoring a site of the mammal that is either exposed, e.g., in surgery or other medical procedures, or protected by skin.

In another aspect, a method of imaging tissue includes introducing a composition including a dye as disclosed herein into the tissue, and detecting emission from the dye. The tissue can be vasculature. The emission can be in the near-infrared (NIR) or infrared wavelength region. Introducing the composition can include injecting the composition into a body, for example, into the vascular system of a body. Detecting emission can include monitoring tissue or tumor vascular during surgery, monitoring body sites of bleeding during surgery, or monitoring tissue perfusion during surgery and surgical repairs.

In another aspect, an imaging system includes a light source capable of being directed at a portion of a patient, e.g., capable of emitting white light and/or an excitation wavelength suitable to excite the infrared fluorescent substance, an imaging composition including a composition including a dye as disclosed herein, and a detector configured to monitor emission from the dye in the patient.

Other features, objects, and advantages will be apparent from the description and drawings, and from the claims.

### BRIEF DESCRIPTION OF FIGURES

The invention will be appreciated more fully from the following further description thereof, with reference to the accompanying drawings, wherein:

FIG. 1 shows the low-pressure gel filtration chromatographic separation of NIR-labeled albumin (left peaks) from preservatives in albumin preparation (right 280 nm peak) and free NIR fluorophore (right 778 nm peak).

FIG. 2 shows the optimization of labeling by varying the ratio of IRDye78-NHS and albumin in the conjugation reaction.

FIG. 3 shows the absorption characteristics of IRDye78 free in solution (IRDye78-CA) or after conjugation to albumin (HSA78).

FIG. 4 shows the fluorescence emission characteristics of IRDye78 free in solution (IRDye78-CA) or after conjugation to albumin (HSA78).

FIG. 5 shows the comparison of fluorescence yield of individual fluorophores after conjugation to HAS to IRDye78 carboxylic acid alone.

FIG. 6 shows the cumulative fluorescence yield of HSA78 maximally substituted with IRDye.

FIG. 7 shows intraoperative vascular mapping using a conjugated compound of the invention in the heart (top) and testis (bottom) at 1 hour post-intravenous injection.

FIG. 8 shows visualization of the site of a liver laceration using a conjugated subject composition.

FIG. 9 shows fluorescence in the kidney and bladder 1 hour after administration of a conjugated subject composition.

FIG. 10 shows the identification of retroperitoneal lymph nodes (white arrows) after injection of a conjugated subject composition into the groin area of a rat.

FIG. 11 shows the fluorescence intensity of conjugated NIR-albumin mapping in comparison to combination NIR-albumin mapping.

FIG. 12a shows the labeling ratio at various mixing ratios for HSA800 (IRDye800CW labeled human serum albumin) and colHSA800 (IRDye800CW labeled albumin nanocolloid).

FIG. 12b shows the fluorescence of agents with each labeling ratio compared to same dye concentration (1 μM) of CW800 in PBS.

FIG. 12c shows the total fluorescence calculated from labeling ratio and fluorescence of one bound label compared to same dye concentration (1 μM) of CW800 in PBS.

FIG. 13a shows the fluorescence of various 800 nm contrast agents compared at the same concentration (1 μM) of dye.

FIG. 13b shows the fluorescence of various 800 nm contrast agents compared at the same concentration (1 μM) of the molecule.

FIG. 14 shows the intraoperative near-infrared fluorescent sentinel lymph node mapping in the skin with HSA800: 100 μL of 10 μM (1 nmol) protein of HSA800 (labeling ratio=3.0) was injected intradermally in the right thigh of the pig. To create the merged image, the NIR fluorescence image was pseudocolored lime green and superimposed on the color image.

FIG. 15 shows intraoperative near-infrared fluorescent sentinel lymph node mapping in the intestine: 100 μl of each agent with indicated concentrations of dye was injected into the parenchyma of the intestine of the pig (arrow), and images were obtained 30 min after injection.

### DETAILED DESCRIPTION

The compositions of the present invention can be used to image tissues, including living tissues, as well as living systems such as lymphatic and circulatory systems. Such compositions can be used to identify the location and size of lymph nodes, to identify the location and size of blood vessels, or to identify the location of a leak of fluid from the lymph or circulatory systems. For example, a surgeon can identify the source of bleeding by injecting a bleeding patient with a subject composition and determining where the dye exits the circulatory system.

One aspect of the invention relates to subject compositions that comprise serum albumin or a fragment thereof, e.g., colloidal serum albumin (such as nanocolloidal serum albumin) or any other form of albumin, that has been chemically modified to bear one or more detectable moieties, such as fluorescent moieties. The serum albumin is preferably the serum albumin native to the patient being treated, e.g., human serum albumin for treating a human. Because serum albumin is non-toxic and has a long half-life under physiological conditions, the modified albumin dyes of the invention survive for extended periods in the body without engendering significant toxic reactions. Accordingly, monitoring of the dye can be conducted over a period of time, e.g., to show changes in a system over time, or to remain detectable over an extended period, e.g., during surgery.

Yet another aspect of the invention relates to subject compositions that comprise a fluorophore that is admixed with serum albumin, e.g., colloidal serum albumin (such as nanocolloidal serum albumin). Such fluorophores may be administered in combination (either simultaneously or sequentially) with the serum albumin, but are preferably combined prior to administration. In certain such embodiments, the fluorophore may be allowed to form a non-covalent complex with the serum albumin prior to administration, e.g., by admixing the fluorophore with the serum albumin (e.g., in an appropriate solvent) and allowing the mixture to stand, e.g., for about 5 to about 10 minutes or more.

Another aspect of the invention relates to a method of imaging either the lymphatic or circulatory system of an animal or any portion thereof, comprising (a) introducing a fluorophore into the animal in admixed with, or conjugated to, serum albumin, e.g., colloidal serum albumin; (b) exposing the animal or portion thereof to light; and (c) detecting an emission wavelength of the imaging agent.

Yet another aspect of the invention relates to a method for sentinel node mapping, comprising (a) introducing a fluorophore (e.g., in the presence or absence of serum albumin) into the animal; (b) exposing the animal or portion thereof to light; and (c) detecting an emission wavelength of the imaging agent. In certain embodiments, the fluorophore is selected from compounds of formula I, compounds of formula II, indocyanine green, IRDye78, IRDye80, IRDye38, IRDye40, IRDye41, IRDye700, IRDye800, IRDye800CW, Cy5, Cy5.5, Cy7, IR-786, DRAQ5NO, Licor NIR, Alexa Fluor680, Alexa Fluor 700, Alexa Fluor 750, La Jolla Blue, quantum dots, and analogs thereof, as well as the fluorophores described in U.S. Pat. No. 6,083,875, incorporated herein by reference in its entirety. In preferred embodiments, the fluorophore is selected from indocyanine green, IRDye78, IRDye80, IRDye38, IRDye40, IRDye41, IRDye700, IRDye800, IRDye800CW, Cy7, IR-786, DRAQ5NO, or an analog thereof. In more preferred such embodiments, the fluorophore is selected from indocyanine green and IRDye800CW.

While in certain embodiments the detectable moiety may be a radiolabeled compound, a metal atom or ion, or any other moiety capable of detection through diagnostic or analytical techniques (preferably non-invasive techniques such as magnetic resonance imaging, X-ray imaging, CAT scans, or other technologies), preferred detectable moieties are fluorescent moieties.

Based on theoretical modeling described below, the two best emission wavelengths for in vivo imaging with dyes are 720-900 nm (NIR dyes) and 1250-400 nm (IR dyes). A number of suitable dyes are discussed below. The term “infrared fluorescent substance” refers to compounds that fluoresce in the infrared region (680 nm to 100,000 nm) of the spectrum, from near infrared (700 nm to 1000 nm) to mid infrared (1000 nm to 20,000 nm) to far infrared (20,000 nm to 100,000 nm). These substances include indocyanine green, IRDye78, IRDye80, IRDye38, IRDye40, IRDye41, IRDye700, IRDye800, IRDye800CW, Cy5, Cy5.5, Cy7, IR-786, DRAQ5NO, Licor NIR, Alexa Fluor680, Alexa Fluor 700, Alexa Fluor 750, La Jolla Blue, quantum dots, and analogs thereof, as well as the fluorophores described in U.S. Pat. No. 6,083,875.

An example of an infrared fluorescent substance is a quantum dot, which may emit at visible light wavelengths, far-red, near-infrared, and infrared wavelengths, and at other wavelengths, typically in response to absorption below their emission wavelength. Quantum dots are a semiconductor nanocrystal with size-dependent optical and electronic properties. In particular, the band gap energy of a quantum dot varies with the diameter of the crystal. Quantum dots (or fluorescent semiconductor nanocrystals) demonstrate quantum confinement effects in their luminescent properties. When quantum dots are illuminated with a primary energy source, a secondary emission of energy occurs of a frequency that corresponds to the band gap of the semiconductor material used in the quantum dot. In quantum confined particles, the band gap is a function of the size of the nanocrystal.

Many semiconductors that are constructed of elements from groups II-VI, III-V and IV of the periodic table have been prepared as quantum sized particles, exhibit quantum confinement effects in their physical properties, and can be used in the composition of the invention. Exemplary materials suitable for use as quantum dots include ZnS, ZnSe, ZnTe, CdS, CdSe, CdTe, GaN, GaP, GaAs, GaSb, InP, InAs, InSb, AlS, AlP, AlAs, AlSb, PbS, PbSe, Ge, and Si and ternary and quaternary mixtures thereof. The quantum dots may further include an overcoating layer of a semiconductor having a greater band gap.

The semiconductor nanocrystals are characterized by their uniform nanometer size. By “nanometer” size, it is meant less than about 150 Angstroms (Å), and preferably in the range of 12-150 Å. The nanocrystals also are substantially monodisperse within the broad nanometer range given above. By monodisperse, as that term is used herein, it is meant a colloidal system in which the suspended particles have substantially identical size and shape. For the purposes of the present invention, monodisperse particles mean that at least 60% of the particles fall within a specified particle size range. Monodisperse particles deviate less than 10% in rms diameter, and preferably less than 5%.

The narrow size distribution of the quantum dots allows the possibility of light emission in narrow spectral widths. Monodisperse quantum dots have been described in detail in Murray et al. (J. Am. Chem. Soc., 115:8706 (1993)); in the thesis of Christopher Murray, “Synthesis and Characterization of II-VI Quantum Dots and Their Assembly into 3-D Quantum Dot Superlattices”, Massachusetts Institute of Technology, September 1995; and in U.S. patent application Ser. No. 08/969,302 entitled “Highly Luminescent Color-selective Materials”.

The fluorescence of semiconductor nanocrystals results from confinement of electronic excitations to the physical dimensions of the nanocrystals. In contrast to the bulk semiconductor material from which these dots are synthesized, these quantum dots have discrete optical transitions, which are tunable with size (U.S. patent application Ser. No. 08/969,302 entitled “Highly Luminescent Color-selective Materials”). Current technology allows good control of their sizes (between 12 to 150 Å; standard deviations approximately 5%), and thus, enables construction of quantum dots that emit light at a desired wavelength throughout the UV-visible-IR spectrum with a quantum yield ranging from 30-50% at room temperature in organic solvents and 10-30% at room temperature in water.

Quantum dots are capable of fluorescence when excited by light. The ability to control the size of quantum dots enables one to construct quantum dots with fluorescent emissions at any wavelength in the UV-visible-IR region. Therefore, the emissions of quantum dots are tunable to any desired spectral wavelength. Furthermore, the emission spectra of monodisperse quantum dots have linewidths as narrow as 25-30 nm. The linewidths are dependent on the size heterogeneity of quantum dots in each preparation.

Appropriate near-infrared fluorescent substances for conjugating to serum albumin or administering in combination with serum albumin may have a structure of formula (I) or formula (II):

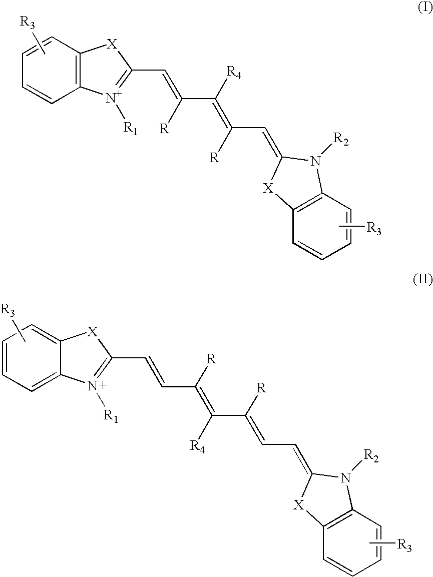

wherein, as valence and stability permit,

X represents C(R)₂, S, Se, O, or NR₅;

R represents H or lower alkyl, or two occurrences of R, taken together, form a ring together with the carbon atoms through which they are connected;

R₁ and R₂ represent, independently, substituted or unsubstituted lower alkyl, lower alkenyl, cycloalkyl, cycloalkylalkyl, aryl, or aralkyl, e.g., optionally substituted by sulfate, phosphate, sulfonate, phosphonate, halogen, hydroxyl, amino, cyano, nitro, carboxylic acid, amide, etc., or a pharmaceutically acceptable salt thereof;

R₃ represents, independently for each occurrence, one or more substituents to the ring to which it is attached, such as a fused ring (e.g., a benzo ring), sulfate, phosphate, sulfonate, phosphonate, halogen, lower alkyl hydroxyl, amino, cyano, nitro, carboxylic acid, amide, etc., or a pharmaceutically acceptable salt thereof;

R₄ represents H, halogen, or a substituted or unsubstituted ether or thioether of phenol or thiophenol; and

R₅ represents, independently for each occurrence, substituted or unsubstituted lower alkyl, cycloalkyl, cycloalkylalkyl, aryl, or aralkyl, e.g., optionally substituted by sulfate, phosphate, sulfonate, phosphonate, halogen, hydroxyl, amino, cyano, nitro, carboxylic acid, amide, etc., or a pharmaceutically acceptable salt thereof.

Dyes representative of the above formulae include indocyanine green, as well as:

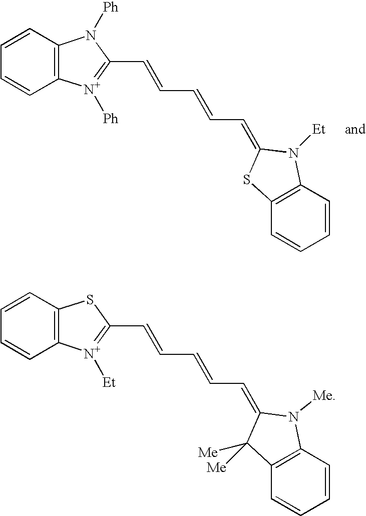

In certain embodiments wherein two occurrences of R taken together form a ring, the ring is six-membered, e.g., the infrared fluorescent dye has a structure of formula (III) or formula (IV):

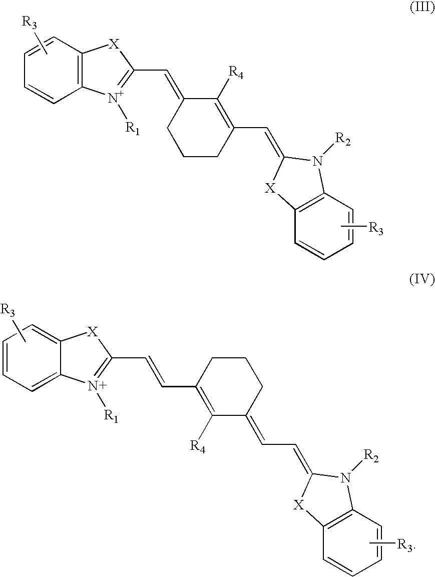

wherein X, R₁, R₂, R₃, R₄, and R₅ represent substituents as described above.

Dyes representative of these formulae include IRDye78, IRDye80, IRDye38, IRDye40, IRDye41, IRDye700, IRDye800, Cy7 (AP Biotech), IRDye800CW, and compounds formed by conjugating a second molecule to any such substance, e.g., a protein or nucleic acid conjugated to IRDye800, IRDye40, or Cy7, IRDye800CW, etc. The IRDyes are commercially available from Li-Cor Biosciences of Lincoln, Nebr., and each dye has a specified peak absorption wavelength (also referred to herein as the excitation wavelength) and peak emission wavelength that may be used to select suitable optical hardware for use therewith. It will be appreciated that other near-infrared or infrared substances may also be conjugated to a protein, such as serum albumin, and such conjugation may change the excitation and emission wavelengths relative to the dye alone. Several specific dyes suited for specific imaging techniques are now described.

In certain embodiments, human serum albumin may be covalently conjugated to a fluorescent dye selected from IRDye78, and IRDye800CW.

In certain embodiments, human serum albumin may be non-covalently associated with a fluorescent dye selected from indocyanine green, IRDye78, IRDye80, IRDye38, IRDye40, IRDye41, IRDye700, IRDye800, IRDye800CW, Cy7, IR-786, DRAQ5NO, or an analog thereof.

In certain embodiments a human serum albumin protein is a colloidal human serum albumin protein. In preferred embodiments, a human serum albumin protein is a nanocolloidal human serum albumin protein.

In certain embodiments, nanocolloidal human serum albumin may be covalently conjugated to indocyanine green or IRDye800CW.

In certain embodiments, nanocolloidal human serum albumin may be non-covalently associated with indocyanine green or IRDye800CW.

IRDye78-CA is useful for imaging the vasculature of the tissues and organs. The dye in its small molecule form is soluble in blood, and has an in vivo early half-life of several minutes. This permits multiple injections during a single procedure. Indocyanine green has similar characteristics, but is somewhat less soluble in blood and has a shorter half-life.

As another example, IR-786 partitions efficiently into mitochondria and/or endoplasmic reticulum in a concentration-dependent manner, thus permitting blood flow and ischemia visualization in a living heart. The dye has been successfully applied, for example, to image blood flow in the heart of a living laboratory rat after a thoracotomy.

Another example of a near-infrared fluorescent dye is DRAQ5NO, a N-oxide modified anthraquinone. Unlike its non-N modified counterpart, DRAQ5NO has a limited capacity to accumulate in within cells and uptake of DRAQ5NO into a cell is increased when the plasma membrane integrity is compromised, i.e., when the cell undergoes cell death. As such, DRAQ5NO may be used for tracking apoptotic populations in tissues, and thus may enhance a targeting effect. DRAQ5NO is available from Biostatus Limited of Leicestershire, UK.

While a number of suitable dyes have been described, it should be appreciated that such infrared fluorescent substances are examples only, and that more generally, any infrared fluorescent substance may be used with the imaging systems described herein, provided the substance has an emission wavelength that does, not interfere with visible light imaging. This includes the near-infrared fluorescent dyes described above, as well as infrared fluorescent substances which may have emission wavelengths above 1000 nm, and may be associated with an antibody, antibody fragment, or ligand and imaged in vivo. All such substances are referred to herein as infrared fluorescent substances, and it will be understood that suitable modifications may be made to components of the imaging system for use with any such infrared fluorescent substance.

The invention can be practiced using purified native, recombinant, or synthetically-prepared serum albumin. The sequence of human serum albumin can be obtained from GenBank under accession numbers AAN17825, CAA23754, and CAA01491.

Serum albumin proteins may be purified as is known in the art, e.g., by standard protein purification procedures, including differential precipitation, molecular sieve chromatography, ion-exchange chromatography, isoelectric focusing, gel electrophoresis and affinity chromatography. Protein preparations can also be concentrated by, for example, filtration (Amicon, Danvers, Mass.).

Any one of the infrared fluorescent substances, preferably a near-infrared fluorescent substance, described above may be employed. In selecting a suitable infrared fluorescent substance, the practitioner will typically consider the particular application of the invention, along with factors common to medical imaging in general. Such factors include (i) the excitation wavelength of the infrared fluorescent substance, (ii) energy of a type and in an amount sufficient to cause the substance to fluoresce, (iii) an emission wavelength of the infrared fluorescent substance that does not interfere with visible light imaging, (iv) suitable chemical form and reactivity of the infrared fluorescent substance, and (v) stability or near stability of the infrared fluorescent substance/targeting moiety conjugate.

Forming a dye of the invention can be accomplished using known techniques. For example, a serum albumin/IRDye78 conjugate can be made by reacting a serum albumin under aqueous conditions to an N-hydroxysuccinimide ester of IRDye78. The unconjugated IRDye78 can be purified from a serum albumin/IRDye78 conjugate through gel filtration or dialysis.

A serum albumin protein can be linked to an infrared fluorescent substance in a number of ways including by chemical coupling means. Covalent conjugates of a serum albumin protein and an infrared fluorescent substance can be prepared by linking chemical moieties of an infrared fluorescent substance to functional groups on amino acid sidechains or at the N-terminus or at the C-terminus of the protein. The serum albumin may also be chemically modified with other chemical moieties, such as glycosyl groups, lipids, phosphate, acetyl groups and the like, to facilitate chemical coupling.

To illustrate, there are a large number of chemical cross-linking agents that are known to those skilled in the art. For the present invention, the preferred cross-linking agents are heterobifunctional cross-linkers, which can be used to link a protein and an infrared fluorescent substance in a stepwise manner. Heterobifunctional cross-linkers provide the ability to design more specific coupling methods for conjugating to proteins, thereby reducing the occurrences of unwanted side reactions such as homo-protein polymers. A wide variety of heterobifunctional cross-linkers are known in the art. These include: succinimidyl 4-(N-maleimidomethyl)cyclohexane-1-carboxylate (SMCC), m-maleimidobenzoyl-N-hydroxysuccinimide ester (MBS); N-succinimidyl (4-iodoacetyl)aminobenzoate (SIAB), succinimidyl 4-(p-maleimidophenyl)butyrate (SMPB), 1-ethyl-3-(3-dimethylaminopropyl)carbodiimide hydrochloride (EDC); 4-succinimidyloxycarbonyl-a-methyl-a-(2-pyridyldithio)-toluene (SMPT), N-succinimidyl 3-(2-pyridyldithio)propionate (SPDP), succinimidyl 6-[3-(2-pyridyldithio)propionate]hexanoate (LC-SPDP). Those cross-linking agents having N-hydroxysuccinimide moieties can be obtained as the N-hydroxysulfosuccinimide analogs, which generally have greater water solubility. In addition, those cross-linking agents having disulfide bridges within the linking chain can be synthesized instead as the alkyl derivatives so as to reduce the amount of linker cleavage in vivo.

In addition to the heterobifunctional cross-linkers, there exist a number of other cross-linking agents including homobifunctional and photoreactive cross-linkers. Disuccinimidyl suberate (DSS), bismaleimidohexane (BMH) and dimethylpimelimidate.2 HCl (DMP) are examples of useful homobifunctional cross-linking agents, and bis-[β-(4-azidosalicylamido)ethyl]disulfide (BASED) and N-succinimidyl-6(4′-azido-2′-nitrophenyl-amino)hexanoate (SANPAH) are examples of useful photoreactive cross-linkers for use in this invention. For a recent review of protein coupling techniques, see Means et al. (1990) Bioconjugate Chemistry 1:2-12, incorporated by reference herein.

One particularly useful class of heterobifunctional cross-linkers, included above, contain the primary amine reactive group, N-hydroxysuccinimide (NHS), or its water-soluble analog N-hydroxysulfosuccinimide (sulfo-NHS). Primary amines (lysine epsilon groups) at alkaline pH's are unprotonated and react by nucleophilic attack on NHS or sulfo-NHS esters. This reaction results in the formation of an amide bond, and release of NHS or sulfo-NHS as a by-product.

Another reactive group useful as part of a heterobifunctional cross-linker is a thiol reactive group. Common thiol reactive groups include maleimides, halogens, and pyridyl disulfides. Maleimides react specifically with free sulfhydryls (cysteine residues) in minutes, under slightly acidic to neutral (pH 6.5-7.5) conditions. Halogens (iodoacetyl functions) react with —SH groups at physiological pH's. Both of these reactive groups result in the formation of stable thioether bonds.

The third component of the heterobifunctional cross-linker is the spacer arm or bridge. The bridge is the structure that connects the two reactive ends. The most apparent attribute of the bridge is its effect on steric hindrance. In some instances, a longer bridge can more easily span the distance necessary to link two complex molecules. For instance, SMPB has a span of 14.5 angstroms.

Using these methods, one or more infrared fluorescent moieties can be conjugated to each serum albumin protein. A higher number or moieties per protein should reduce the amount of the composition necessary to achieve a desired level of fluorescence in the treated tissue or fluid, and may provide a stronger signal per unit volume of tissue or fluid, thereby assisting detection and measurement of fluorescence.

One potential application of subject compositions is as fluorescent contrast agents for biomedical imaging. However, in vivo applications, and especially reflectance fluorescence imaging (the impetus for this study), require deep photon penetration into and out of tissue. In living tissue, total photon attenuation is the sum of attenuation due to absorbance and scatter. Scatter describes the deviation of a photon from the parallel axis of its path, and can occur when the tissue inhomogeneity is small relative to wavelength (Rayleigh-type scatter), or roughly on the order of wavelength (Mie-type scatter). For inhomogeneities at least ten times less than the wavelength, Rayleigh-type scatter is proportional to the reciprocal 4^{th} power of wavelength. In living tissue, photon scatter is the result of multiple scattering events, and in general terms can be considered either dependent on wavelength or independent of wavelength. For example, in rat skin, scatter is proportional to λ^{-2.8}, suggesting strong wavelength-dependence, however, in post-menopausal human breast, scatter is proportional to λ^{-0.6}, suggesting weak wavelength-dependence. See, for example, Zaheer et al., Nature Biotechol. 19:1148-1154 (2001); Nakayama et al., “Functional near-infrared fluorescence imaging for cardiac surgery and targeted gene therapy,” Molecular Imaging (2002); Cheong et al., IEEE J. Quantum Electronics 26:2166-2195 (1990); and Cerussi et al., Acad. Radiol. 8:211-218 (2001), each of which is incorporated by reference in its entirety.

Given the relatively low absorbance and scatter of living tissue in the near-infrared (NIR; 700 nm to 1000 nm) region of the spectrum, considerable attention has focused on NIR fluorescence contrast agents. For example, conventional NIR fluorophores with peak emission between 700 nm and 800 nm have been used for in vivo imaging of protease activity, somatostatin receptors, sites of hydroxylapatite deposition, and myocardial vascularity, to name a few.

One surgical procedure during which radiation is used routinely is sentinel lymph node (SLN) mapping and biopsy. The underlying hypothesis of SLN mapping is that the first lymph node to receive lymphatic drainage from a tumor site will show tumor if there has been lymphatic spread. SLNs can be identified using radio-guided lymphatic mapping and/or by visualization of the nodes with vital blue dyes. Histopathological evaluation of SLNs provides accurate staging of cancer, and can guide regional and systematic treatment. Importantly, for breast cancer, axillary node dissection and its associated morbidity can be avoided in patients whom the SLN is negative histologically. Another benefit of SLN mapping is that it affords excellent regional control in the patient with palpable tumor-containing nodes. This light-based approach can replace radioactivity and blue dyes, can permits imaging of lymph node flow in real-time, not just approximate positions given by radioactive tracers, and can permits even deep lymph nodes to be mapped by monitoring emitted NIR or IR wavelength ranges.

The subject dyes can be incorporated into compositions, such as an injectable preparation that can include an acceptable diluent, or a slow release matrix in which the nanocrystal is imbedded. The composition can be provided in a container, pack, or dispenser together with instructions for administration. The composition can be formulated in accordance with its intended route of administration. Acceptable routes include oral or parenteral routes (e.g., intravenous, intradermal, transdermal (e.g., subcutaneous or topical), intraparenchymal, or transmucosal (i.e., across a membrane that lines the respiratory or anogenital tract). The compositions can be formulated as a solution or suspension and, thus, can include a sterile diluent (e.g., water, saline solution, a fixed oil, polyethylene glycol, glycerine, propylene glycol or another synthetic solvent); an antimicrobial agent (e.g., benzyl alcohol or methyl parabens; chlorobutanol, phenol, ascorbic acid, thimerosal, and the like); an antioxidant (e.g., ascorbic acid or sodium bisulfite); a chelating agent (e.g., ethylenediaminetetraacetic acid); or a buffer (e.g., an acetate-, citrate-, or phosphate-based buffer). When necessary, the pH of the solution or suspension can be adjusted with an acid (e.g., hydrochloric acid) or a base (e.g., sodium hydroxide). Proper fluidity (which can ease passage through a needle) can be maintained by a coating such as lecithin, by maintaining the required particle size (in the case of a dispersion), or by the use of surfactants. The body can be an animal (e.g., a rabbit, mouse, guinea pig, rat, horse, cow, pig, dog, cat or human).

### CHEMICAL DEFINITIONS

‘Acyl’ refers to a group suitable for acylating a nitrogen atom to form an amide or carbamate, a carbon atom to form a ketone, a sulfur atom to form a thioester, or an oxygen atom to form an ester group, e.g., a hydrocarbon attached to a —C(═O)— moiety. Preferred acyl groups include benzoyl, acetyl, tert-butyl acetyl, pivaloyl, and trifluoroacetyl. More preferred acyl groups include acetyl and benzoyl. The most preferred acyl group is acetyl.

The terms ‘amine’ and ‘amino’ are art-recognized and refer to both unsubstituted and substituted amines as well as ammonium salts, e.g., as can be represented by the general formula:

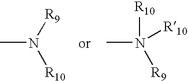

wherein R₉, R₁₀, and R′₁₀ each independently represent hydrogen or a hydrocarbon substituent, or R₉ and R₁₀ taken together with the N atom to which they are attached complete a heterocycle having from 4 to 8 atoms in the ring structure. In preferred embodiments, none of R₉, R₁₀, and R′₁₀ is acyl, e.g., R₉, R₁₀, and R′₁₀ are selected from hydrogen, alkyl, heteroalkyl, aryl, heteroaryl, carbocyclic aliphatic, and heterocyclic aliphatic. The term ‘alkylamine’ as used herein means an amine group, as defined above, having at least one substituted or unsubstituted alkyl attached thereto. Amino groups that are positively charged (e.g., R′₁₀ is present) are referred to as ‘ammonium’ groups. In amino groups other than ammonium groups, the amine is preferably basic, e.g., its conjugate acid has a pKₐ above 7.

The terms ‘amido’ and ‘amide’ are art-recognized as an amino-substituted carbonyl, such as a moiety that can be represented by the general formula:

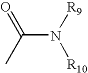

wherein R₉ and R₁₀ are as defined above. In certain embodiments, the amide will include imides.

‘Alkyl’ refers to a saturated or unsaturated hydrocarbon chain having 1 to 18 carbon atoms, preferably 1 to 12, more preferably 1 to 6, more preferably still 1 to 4 carbon atoms. Alkyl chains may be straight (e.g., n-butyl) or branched (e.g., sec-butyl, isobutyl, or t-butyl). Preferred branched alkyls have one or two branches, preferably one branch. Preferred alkyls are saturated. Unsaturated alkyls have one or more double bonds and/or one or more triple bonds. Preferred unsaturated alkyls have one or two double bonds or one triple bond, more preferably one double bond. Alkyl chains may be unsubstituted or substituted with from 1 to 4 substituents. Preferred alkyls are unsubstituted. Preferred substituted alkyls are mono-, di-, or trisubstituted. Preferred alkyl substituents include halo, haloalkyl, hydroxy, aryl (e.g., phenyl, tolyl, alkoxyphenyl, alkyloxycarbonylphenyl, halophenyl), heterocyclyl, and heteroaryl.

The terms ‘alkenyl’ and ‘alkynyl’ refer to unsaturated aliphatic groups analogous in length and possible substitution to the alkyls described above, but that contain at least one double or triple bond, respectively. When not otherwise indicated, the terms alkenyl and alkynyl preferably refer to lower alkenyl and lower alkynyl groups, respectively. When the term alkyl is present in a list with the terms alkenyl and alkynyl, the term alkyl refers to saturated alkyls exclusive of alkenyls and alkynyls.

The terms ‘alkoxyl’ and ‘alkoxy’ as used herein refer to an —O-alkyl group. Representative alkoxyl groups include methoxy, ethoxy, propyloxy, tert-butoxy, and the like. An ‘ether’ is two hydrocarbons covalently linked by an oxygen. Accordingly, the substituent of a hydrocarbon that renders that hydrocarbon an ether can be an alkoxyl, or another moiety such as —O-aryl, —O-heteroaryl, —O-heteroalkyl, —O-aralkyl, —O-heteroaralkyl, —O-carbocylic aliphatic, or —O-heterocyclic aliphatic.

The term ‘aralkyl’, as used herein, refers to an alkyl group substituted with an aryl group.

‘Aryl ring’ refers to an aromatic hydrocarbon ring system. Aromatic rings are monocyclic or fused bicyclic ring systems, such as phenyl, naphthyl, etc. Monocyclic aromatic rings contain from about 5 to about 10 carbon atoms, preferably from 5 to 7 carbon atoms, and most preferably from 5 to 6 carbon atoms in the ring. Bicyclic aromatic rings contain from 8 to 12 carbon atoms, preferably 9 or 10 carbon atoms in the ring. The term ‘aryl’ also includes bicyclic ring systems wherein only one of the rings is aromatic, e.g., the other ring is cycloalkyl, cycloalkenyl, or heterocyclyl. Aromatic rings may be unsubstituted or substituted with from 1 to about 5 substituents on the ring. Preferred aromatic ring substituents include: halo, cyano, lower alkyl, heteroalkyl, haloalkyl, phenyl, phenoxy, or any combination thereof. More preferred substituents include lower alkyl, cyano, halo, and haloalkyl.

‘Cycloalkyl ring’ refers to a saturated or unsaturated hydrocarbon ring. Cycloalkyl rings are not aromatic. Cycloalkyl rings are monocyclic, or are fused, spiro, or bridged bicyclic ring systems. Monocyclic cycloalkyl rings contain from about 4 to about 10 carbon atoms, preferably from 4 to 7 carbon atoms, and most preferably from 5 to 6 carbon atoms in the ring. Bicyclic cycloalkyl rings contain from 8 to 12 carbon atoms, preferably from 9 to 10 carbon atoms in the ring. Cycloalkyl rings may be unsubstituted or substituted with from 1 to 4 substituents on the ring. Preferred cycloalkyl ring substituents include halo, cyano, alkyl, heteroalkyl, haloalkyl, phenyl, phenoxy or any combination thereof. More preferred substituents include halo and haloalkyl. Preferred cycloalkyl rings include cyclopentyl, cyclohexyl, cyclohexenyl, cycloheptyl, and cyclooctyl. More preferred cycloalkyl rings include cyclohexyl, cycloheptyl, and cyclooctyl.

The term ‘carbonyl’ is art-recognized and includes such moieties as can be represented by the general formula:

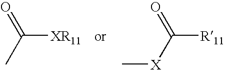

wherein X is a bond or represents an oxygen or a sulfur, and R₁₁ represents a hydrogen, hydrocarbon substituent, or a pharmaceutically acceptable salt, R_{11′} represents a hydrogen or hydrocarbon substituent. Where X is an oxygen and R₁₁ or R_{11′} is not hydrogen, the formula represents an ‘ester’. Where X is an oxygen, and R₁₁ is as defined above, the moiety is referred to herein as a carboxyl group, and particularly when R₁₁ is a hydrogen, the formula represents a ‘carboxylic acid’. Where X is an oxygen, and R_{11′} is hydrogen, the formula represents a ‘formate’. In general, where the oxygen atom of the above formula is replaced by sulfur, the formula represents a ‘thiocarbonyl’ group. Where X is a sulfur and R₁₁ or R_{11′} is not hydrogen, the formula represents a ‘thioester.’ Where X is a sulfur and R₁₁ is hydrogen, the formula represents a ‘thiocarboxylic acid.’ Where X is a sulfur and R_{11′} is hydrogen, the formula represents a ‘thioformate.’ On the other hand, where X is a bond, R₁₁ is not hydrogen, and the carbonyl is bound to a hydrocarbon, the above formula represents a ‘ketone’ group. Where X is a bond, R₁₁ is hydrogen, and the carbonyl is bound to a hydrocarbon, the above formula represents an ‘aldehyde’ or ‘formyl’ group.

‘Ci alkyl’ is an alkyl chain having i member atoms. For example, C4 alkyls contain four carbon member atoms. C4 alkyls containing may be saturated or unsaturated with one or two double bonds (cis or trans) or one triple bond. Preferred C4 alkyls are saturated. Preferred unsaturated C4 alkyl have one double bond. C4 alkyl may be unsubstituted or substituted with one or two substituents. Preferred substituents include lower alkyl, lower heteroalkyl, cyano, halo, and haloalkyl.

‘Halogen’ refers to fluoro, chloro, bromo, or iodo substituents. Preferred halo are fluoro, chloro and bromo; more preferred are chloro and fluoro.

‘Heteroalkyl’ is a saturated or unsaturated chain of carbon atoms and at least one heteroatom, wherein no two heteroatoms are adjacent. Heteroalkyl chains contain from 1 to 18 member atoms (carbon and heteroatoms) in the chain, preferably 1 to 12, more preferably 1 to 6, more preferably still 1 to 4. Heteroalkyl chains may be straight or branched. Preferred branched heteroalkyl have one or two branches, preferably one branch. Preferred heteroalkyl are saturated. Unsaturated heteroalkyl have one or more double bonds and/or one or more triple bonds. Preferred unsaturated heteroalkyl have one or two double bonds or one triple bond, more preferably one double bond. Heteroalkyl chains may be unsubstituted or substituted with from 1 to about 4 substituents unless otherwise specified. Preferred heteroalkyl are unsubstituted. Preferred heteroalkyl substituents include halo, aryl (e.g., phenyl, tolyl, alkoxyphenyl, alkoxycarbonylphenyl, halophenyl), heterocyclyl, heteroaryl. For example, alkyl chains substituted with the following substituents are heteroalkyl: alkoxy (e.g., methoxy, ethoxy, propoxy, butoxy, pentoxy), aryloxy (e.g., phenoxy, chlorophenoxy, tolyloxy, methoxyphenoxy, benzyloxy, alkoxycarbonylphenoxy, acyloxyphenoxy), acyloxy (e.g., propionyloxy, benzoyloxy, acetoxy), carbamoyloxy, carboxy, mercapto, alkylthio, acylthio, arylthio (e.g., phenylthio, chlorophenylthio, alkylphenylthio, alkoxyphenylthio, benzylthio, alkoxycarbonylphenylthio), amino (e.g., amino, mono- and di-C1-C3 alkylamino, methylphenylamino, methylbenzylamino, C1-C3 alkylamido, carbamamido, ureido, guanidino).

‘Heteroatom’ refers to a multivalent non-carbon atom, such as a boron, phosphorous, silicon, nitrogen, sulfur, or oxygen atom, preferably a nitrogen, sulfur, or oxygen atom. Groups containing more than one heteroatom may contain different heteroatoms.

‘Heteroaryl ring’ refers to an aromatic ring system containing carbon and from 1 to about 4 heteroatoms in the ring. Heteroaromatic rings are monocyclic or fused bicyclic ring systems. Monocyclic heteroaromatic rings contain from about 5 to about 10 member atoms (carbon and heteroatoms), preferably from 5 to 7, and most preferably from 5 to 6 in the ring. Bicyclic heteroaromatic rings contain from 8 to 12 member atoms, preferably 9 or 10 member atoms in the ring. The term ‘heteroaryl’ also includes bicyclic ring systems wherein only one of the rings is aromatic, e.g., the other ring is cycloalkyl, cycloalkenyl, or heterocyclyl. Heteroaromatic rings may be unsubstituted or substituted with from 1 to about 4 substituents on the ring. Preferred heteroaromatic ring substituents include halo, cyano, lower alkyl, heteroalkyl, haloalkyl, phenyl, phenoxy or any combination thereof. Preferred heteroaromatic rings include thienyl, thiazolyl, oxazolyl, pyrrolyl, purinyl, pyrimidyl, pyridyl, and furanyl. More preferred heteroaromatic rings include thienyl, furanyl, and pyridyl.

‘Heterocyclic aliphatic ring’ is a non-aromatic saturated or unsaturated ring containing carbon and from 1 to about 4 heteroatoms in the ring, wherein no two heteroatoms are adjacent in the ring and preferably no carbon in the ring attached to a heteroatom also has a hydroxyl, amino, or thiol group attached to it. Heterocyclic aliphatic rings are monocyclic, or are fused or bridged bicyclic ring systems. Monocyclic heterocyclic aliphatic rings contain from about 4 to about 10 member atoms (carbon and heteroatoms), preferably from 4 to 7, and most preferably from 5 to 6 member atoms in the ring. Bicyclic heterocyclic aliphatic rings contain from 8 to 12 member atoms, preferably 9 or 10 member atoms in the ring. Heterocyclic aliphatic rings may be unsubstituted or substituted with from 1 to about 4 substituents on the ring. Preferred heterocyclic aliphatic ring substituents include halo, cyano, lower alkyl, heteroalkyl, haloalkyl, phenyl, phenoxy or any combination thereof. More preferred substituents include halo and haloalkyl. Heterocyclyl groups include, for example, thiophene, thianthrene, furan, pyran, isobenzofuran, chromene, xanthene, phenoxathin, pyrrole, imidazole, pyrazole, isothiazole, isoxazole, pyridine, pyrazine, pyrimidine, pyridazine, indolizine, isoindole, indole, indazole, purine, quinolizine, isoquinoline, hydantoin, oxazoline, imidazolinetrione, triazolinone, quinoline, phthalazine, naphthyridine, quinoxaline, quinazoline, quinoline, pteridine, carbazole, carboline, phenanthridine, acridine, phenanthroline, phenazine, phenarsazine, phenothiazine, furazan, phenoxazine, pyrrolidine, oxolane, thiolane, oxazole, piperidine, piperazine, morpholine, lactones, lactams such as azetidinones and pyrrolidinones, sultams, sultones, and the like. Preferred heterocyclic aliphatic rings include piperazyl, morpholinyl, tetrahydrofuranyl, tetrahydropyranyl and piperidyl. Heterocycles can also be polycycles.

The term ‘hydroxyl’ means —OH.

‘Lower alkyl’ refers to an alkyl chain comprised of 1 to 4, preferably 1 to 3 carbon member atoms, more preferably 1 or 2 carbon member atoms. Lower alkyls may be saturated or unsaturated. Preferred lower alkyls are saturated. Lower alkyls may be unsubstituted or substituted with one or about two substituents. Preferred substituents on lower alkyl include cyano, halo, trifluoromethyl, amino, and hydroxyl. Throughout the application, preferred alkyl groups are lower alkyls. In preferred embodiments, a substituent designated herein as alkyl is a lower alkyl. Likewise, ‘lower alkenyl’ and ‘lower alkynyl’ have similar chain lengths.

‘Lower heteroalkyl’ refers to a heteroalkyl chain comprised of 1 to 4, preferably 1 to 3 member atoms, more preferably 1 to 2 member atoms. Lower heteroalkyl contain one or two non-adjacent heteroatom member atoms. Preferred lower heteroalkyl contain one heteroatom member atom. Lower heteroalkyl may be saturated or unsaturated. Preferred lower heteroalkyl are saturated. Lower heteroalkyl may be unsubstituted or substituted with one or about two substituents. Preferred substituents on lower heteroalkyl include cyano, halo, trifluoromethyl, and hydroxyl.

‘Mi heteroalkyl’ is a heteroalkyl chain having i member atoms. For example, M4 heteroalkyls contain one or two non-adjacent heteroatom member atoms. M4 heteroalkyls containing 1 heteroatom member atom may be saturated or unsaturated with one double bond (cis or trans) or one triple bond. Preferred M4 heteroalkyl containing 2 heteroatom member atoms are saturated. Preferred unsaturated M4 heteroalkyl have one double bond. M4 heteroalkyl may be unsubstituted or substituted with one or two substituents. Preferred substituents include lower alkyl, lower heteroalkyl, cyano, halo, and haloalkyl.

‘Member atom’ refers to a polyvalent atom (e.g., C, O, N, or S atom) in a chain or ring system that constitutes a part of the chain or ring. For example, in cresol, six carbon atoms are member atoms of the ring and the oxygen atom and the carbon atom of the methyl substituent are not member atoms of the ring.

As used herein, the term ‘nitro’ means —NO2.

‘Pharmaceutically acceptable salt’ refers to a cationic salt formed at any acidic (e.g., hydroxamic or carboxylic acid) group, or an anionic salt formed at any basic (e.g., amino or guanidino) group. Such salts are well known in the art. See e.g., World Patent Publication 87/05297, Johnston et al., published Sep. 11, 1987, incorporated herein by reference. Such salts are made by methods known to one of ordinary skill in the art. It is recognized that the skilled artisan may prefer one salt over another for improved solubility, stability, formulation ease, price and the like. Determination and optimization of such salts is within the purview of the skilled artisan's practice. Preferred cations include the alkali metals (such as sodium and potassium), and alkaline earth metals (such as magnesium and calcium) and organic cations, such as trimethylammonium, tetrabutylammonium, etc. Preferred anions include halides (such as chloride), sulfonates, carboxylates, phosphates, and the like. Clearly contemplated in such salts are addition salts that may provide an optical center where once there was none. For example, a chiral tartrate salt may be prepared from the compounds of the invention. This definition includes such chiral salts.

‘Phenyl’ is a six-membered monocyclic aromatic ring that may or may not be substituted with from 1 to 5 substituents. The substituents may be located at the ortho, meta or para position on the phenyl ring, or any combination thereof. Preferred phenyl substituents include: halo, cyano, lower alkyl, heteroalkyl, haloalkyl, phenyl, phenoxy or any combination thereof. More preferred substituents on the phenyl ring include halo and haloalkyl. The most preferred substituent is halo.

The terms ‘polycyclyl’ and ‘polycyclic group’ refer to two or more rings (e.g., cycloalkyls, cycloalkenyls, heteroaryls, aryls and/or heterocyclyls) in which two or more member atoms of one ring are member atoms of a second ring. Rings that are joined through non-adjacent atoms are termed ‘bridged’ rings, and rings that are joined through adjacent atoms are ‘fused rings’.

The term ‘sulfate’ is art-recognized and includes a moiety that can be represented by the general formula:

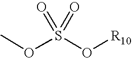

in which R₁₀ is as defined above.

A ‘substitution’ or ‘substituent’ on a small organic molecule generally refers to a position on a multivalent atom bound to a moiety other than hydrogen, e.g., a position on a chain or ring exclusive of the member atoms of the chain or ring. Such moieties include those defined herein and others as are known in the art, for example, halogen, alkyl, alkenyl, alkynyl, azide, haloalkyl, hydroxyl, carbonyl (such as carboxyl, alkoxycarbonyl, formyl, ketone, or acyl), thiocarbonyl (such as thioester, thioacetate, or thioformate), alkoxyl, phosphoryl, phosphonate, phosphinate, amine, amide, amidine, imine, cyano, nitro, azido, sulfhydryl, alkylthio, sulfate, sulfonate, sulfamoyl, sulfonamido, sulfonyl, silyl, ether, cycloalkyl, heterocyclyl, heteroalkyl, heteroalkenyl, and heteroalkynyl, heteroaralkyl, aralkyl, aryl or heteroaryl. It will be understood by those skilled in the art that certain substituents, such as aryl, heteroaryl, polycyclyl, alkoxy, alkylamino, alkyl, cycloalkyl, heterocyclyl, alkenyl, alkynyl, heteroalkyl, heteroalkenyl, and heteroalkynyl, can themselves be substituted, if appropriate. This invention is not intended to be limited in any manner by the permissible substituents of organic compounds. It will be understood that ‘substitution’ or ‘substituted with’ includes the implicit proviso that such substitution is in accordance with permitted valence of the substituted atom and the substituent, and that the substitution results in a stable compound, e.g., which does not spontaneously undergo transformation such as by rearrangement, cyclization, elimination, hydrolysis, etc.

As used herein, the definition of each expression, e.g., alkyl, m, n, etc., when it occurs more than once in any structure, is intended to be independent of its definition elsewhere in the same structure.

The abbreviations Me, Et, Ph, Tf, Nf, Ts, and Ms represent methyl, ethyl, phenyl, trifluoromethanesulfonyl, nonafluorobutanesulfonyl, p-toluenesulfonyl, and methanesulfonyl, respectively. A more comprehensive list of the abbreviations utilized by organic chemists of ordinary skill in the art appears in the first issue of each volume of the Journal of Organic Chemistry; this list is typically presented in a table entitled Standard List of Abbreviations. The abbreviations contained in said list, and all abbreviations utilized by organic chemists of ordinary skill in the art are hereby incorporated by reference.

For purposes of this invention, the chemical elements are identified in accordance with the Periodic Table of the Elements, CAS version, Handbook of Chemistry and Physics, 67th Ed., 1986-87, inside cover. Also for purposes of this invention, the term ‘hydrocarbon’ is contemplated to include all permissible compounds or moieties having at least one carbon-hydrogen bond. In a broad aspect, the permissible hydrocarbons include acyclic and cyclic, branched and unbranched, carbocyclic and heterocyclic, aromatic and nonaromatic organic compounds which can be substituted or unsubstituted.

### EXEMPLIFICATION

### Example 1

Albumin was rendered near-infrared fluorescent by reaction with the N-hydroxysuccinimide (NHS) ester of IRDye78 under conditions found to be optimal. Purification was effected by low-pressure gel filtration chromatography on a P-6 (Bio-Rad) econo-cartridge (see FIG. 1). Final purity of the product was >95%. The optimal labeling conditions were determined by varying the ratio of fluorophore to albumin (see FIG. 2) as well as the pH (not shown). Optimal labeling was found to occur in phosphate buffered saline, pH 7.8. IRDye78-NHS was added last to start the reaction and the tube was vortexed for 2 h in the dark. Optimal conditions for the final concentrations in labeling reactions were as follows:

Albumin: 180 μM

IRDye78-NHS (from a stock in DMSO): 1 mM

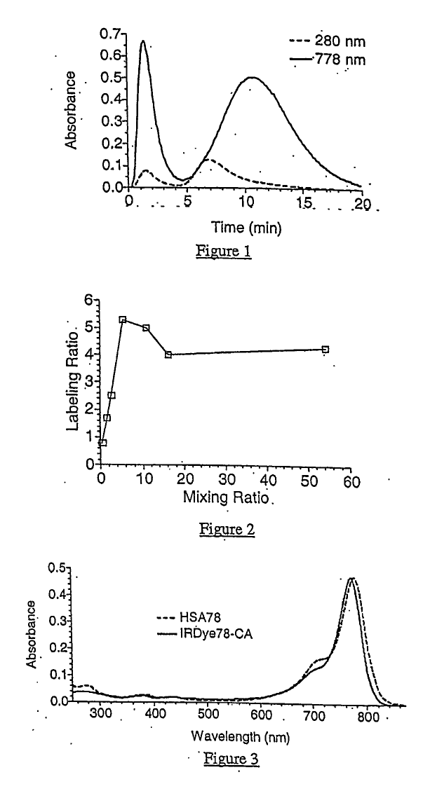

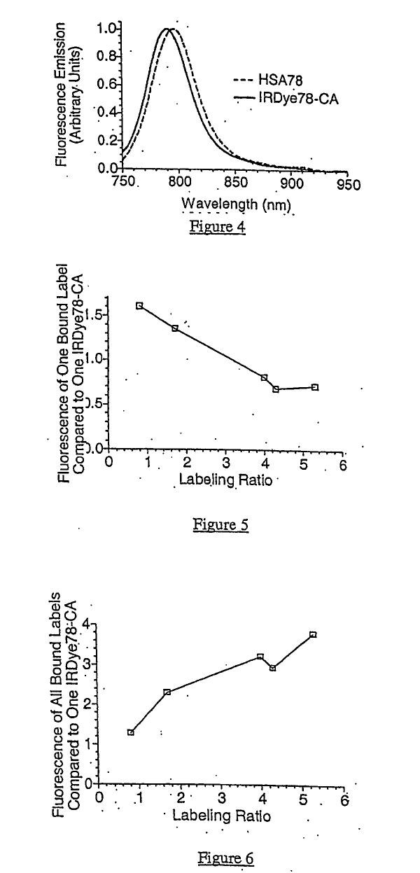

Once the optimal conditions were determined, the optical properties of the purified product (near infrared albumin—NIR-albumin) were carefully characterized with respect to absorbance (FIG. 3; a slight red-shift occurs relative to unconjugated fluorophore) and emission (FIG. 4; a slight red-shift occurs relative to unconjugated fluorophore). The conditions were then optimized to provide a maximally substituted NIR albumin with the highest possible total quantum yield (see FIGS. 5 and 6).

With the highest possible total fluorescence yield in hand, the efficacy of NIR albumin in intravascular mapping and identification of sites of bleeding was demonstrated. FIG. 7 shows the heart vasculature and testis 1 hour after intravenous injection of 26 nmol of NIR annexin into a 250 g Sprague-Dawley rat. The signal-to-background ratio for the vasculature was similar to the 5 min time point, suggesting that the NIR albumin has a long intravenous half-life.

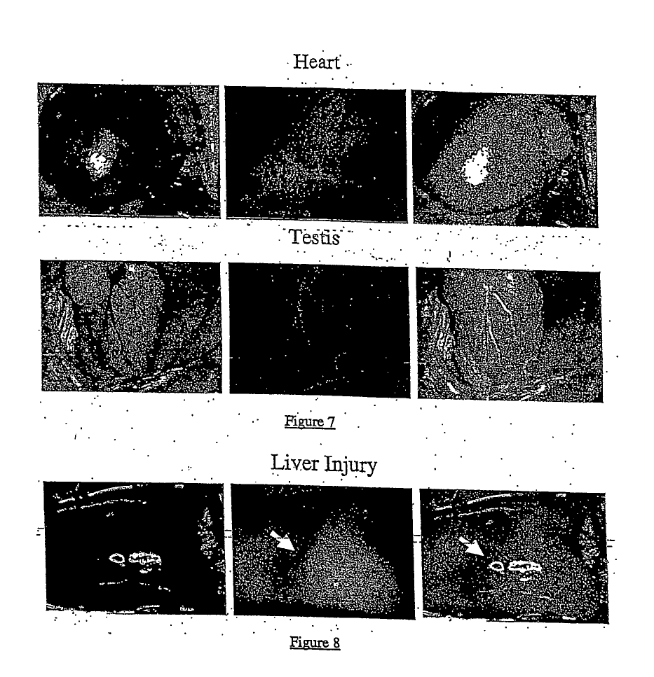

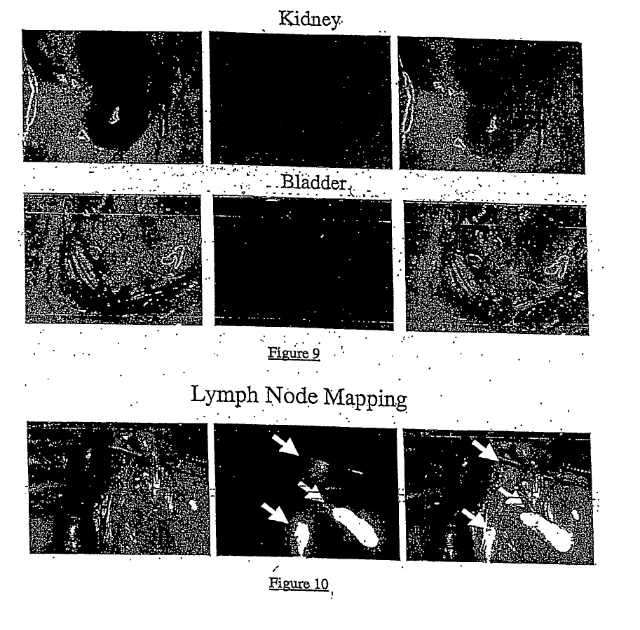

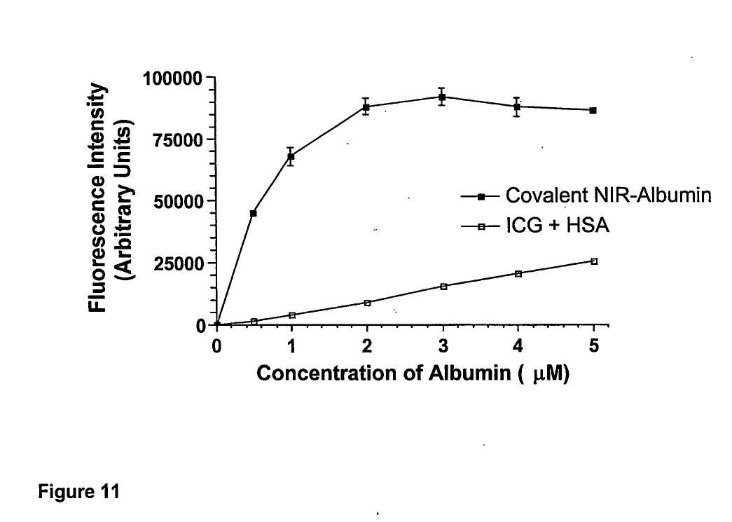

To demonstrate applicability for identification of sites of bleeding intraoperatively, a model using a lacerated liver was used. FIG. 8 shows a liver with a laceration, where the liver itself is bright in the NIR due to NIR albumin concentration in the liver. After lacerating the liver (white arrow), blood covered the liver (color video image). Using the NIR channel, however, the site of the laceration was seen clearly since NIR light penetrates blood much better than visible light, and the site of the laceration was seen as a dark line in the otherwise homogeneously bright liver. Additionally, there was virtually no signal in the kidney or bladder after 1 hour, which indicates high stability of the dye-fluorophore conjugate on the protein and that the protein itself is not breaking down (see FIG. 9).

Suitability for lymph node mapping was then demonstrated. FIG. 10 shows the identification of retroperitoneal lymph nodes (white arrows) after injection of 5 nmol of NIR albumin into the groin area of a rat. Again, there was virtually no signal in the kidney or bladder after 1 hour, suggesting high stability of the dye-fluorophore conjugate.

### Example 2

The optical and physical properties of disulfonated indocyanine green (ICG, 775 Da), 800CW, 962 Da, ICG non-covalently associated with albumin (ICGHSA, 67 KDa), CW800-labeled human serum albumin (HSA800, 70 KDa), and CW800-labeled albumin nanocolloid (colHSA800, 7 MDa) were characterized in terms of optimal labeling ratio, relative fluorescent yield, hydrodynamic diameter, estimated net charge and excitation/emission wavelength maximum, and compared them to QDs (440 KDa). The performance of these agents in rat and pig model systems of SLN mapping for the skin, gastrointestinal tract and lung were also quantitated.

In phosphate-buffered saline, the relative per molecule fluorescent yield of ICG, 800CW, ICGHSA, HSA800, colHSA800 to QDs was 0.1, 0.4, 0.1, 0.4, 0.2, respectively. In 100% fetal bovine serum, the relative per molecule fluorescent yield was 0.4, 1.0, 0.3, 0.8, 0.3, respectively. For SLN mapping of the skin, intestine and lung, HSA800 had the best performance of the organic contrast agents with respect to fluorescent yield, lymphatic access, SLN retention and image guidance.

### Example 3

### Synthesis of HSA800 and colHSA800

The N-hydroxysuccinimide (NHS) ester of 800CW (800CW-NHS) was from LI-COR (Lincoln, Nebr.). All steps were performed under reduced light conditions. All conjugation reactions contained 5 mg/ml HSA or 10 mg/ml albumin nanocolloid (NanoColl powder Amersham Health) and various amount of 800CW-NHS in PBS, pH 7.8, and were performed at room temperature with constant agitation in the dark for 3 hrs. The purification was performed with Econo-Pac P6 chromatographic cartridge with a MW cut-off of 6,000 (Bio-Rad), connected to flow spectrometer, followed by fraction collector. The spectral range of the system is from 200 nm to 870 nm. After conjugation, the sample was loaded to the injector and run at a flow rate of 0.5 mL/min with PBS, pH 7.8. By monitoring the spectrometer, the first eluate, which is considered to be HSA800 or colHSA800, was collected in separate tubes by the fraction collector. Then optimal fractions were selected according to the recorded data, combined together, and stored at 4° C. until use. Labeling ratio was estimated using ε785 nm=240,000 M/cm and 6280 nm=32,900 M/cm and as follows, taking into account that 6.5% of absorbance of CW800 at 775 nm contributes to that of at 280 nm.

Labeling ratio=(A785/ε785 nm)/((A280−0.065×A785)/ε280 nm)

### Fluorescence Spectrometry

All of the samples were diluted with PBS, pH7.8, or with 100% FBS according to absorbance at λmax using 1-cm path length quartz spectrometer cell, and excited at 770 nm. Fluorescence was measured by calculating the area under the curve of the intensity from 785 nm to 950 nm subtracting the fluorescence of control PBS, pH 7.8.

### Quantum Yield Measurements

Quantum yields of ICG, CW800, ICGHSA (mixture of same moles of ICG and HSA), HSA800, QDs and colHSA800 were measured in solution in PBS, pH 7.8 or in 100% FBS, by comparison to ICG in DMSO as a control (13%) under condition of matched fluorophore absorbance.

### Sentinel Lymph Node Mapping

Animal protocols were in accordance with Institutional Animal Care and Use Committee Guidelines. Adult male Sprague Yorkshire pigs of 35 kg were used. After anesthesia, 100 μL of 10 μM (1 nmol) HSA800, CW800, ICG, ICGHSA, 4 μM colHSA800 or 0.4 μM QDs in PBS, pH7.8 were injected into the thigh intradermally, and into the parenchyma of the intestine and lung, and werewas monitored in real time with the NIR fluorescence imaging system.

### Results

Synthesis of HSA800 and colHSA800

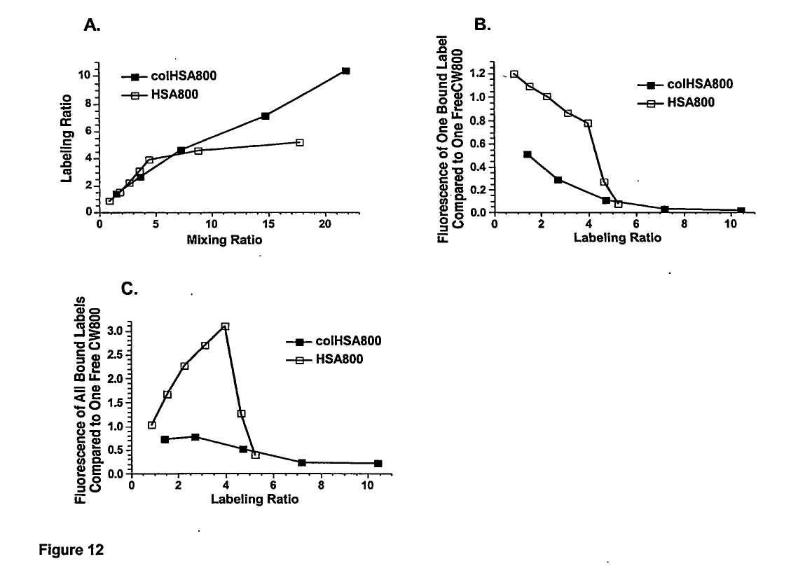

After reaction of CW800-NHS with HSA or albumin nanocolloid, the product was purified with gel filtration cartridge. In our experiment condition, the labeling ratio was increased as the mixing ratio got higher (FIG. 12A). However, as the labeling ratio got higher, the fluorescence of one bound label compared to one free CW800 was decreased (FIG. 12B). Because of that, fluorescence of all bound labels of HSA800 and colHSA800 compared to one free CW800 was best at the labeling ratio of 4.0, and 2.7, respectively (FIG. 12C). HSA800 with the labeling ratio of 3.0 and colHSA800 with the labeling ratio of 2.7 were used for further analysis.

### Physical and Optical Properties of a Family of 800 nm Contrast Agents

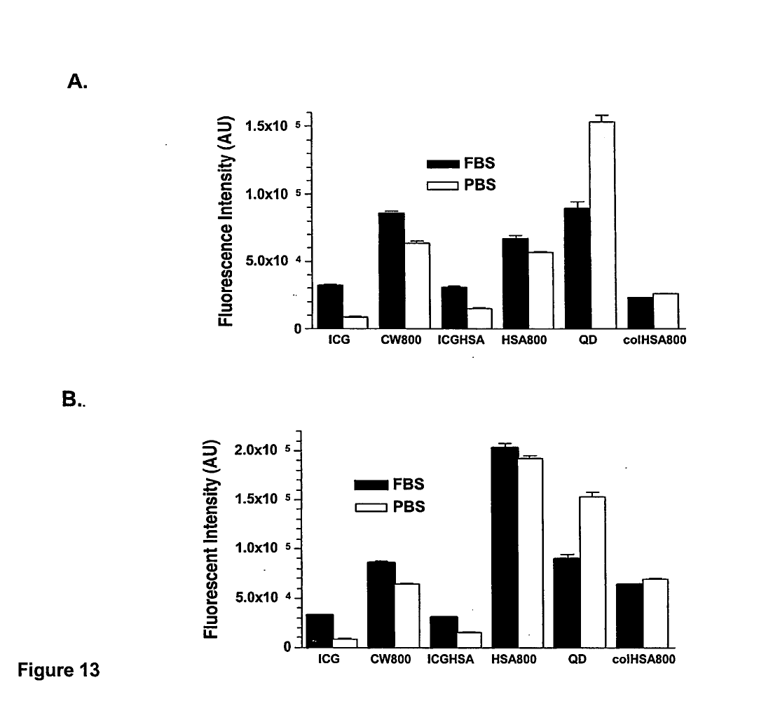

Physical and optical properties of the contrast agents studied here are summarized in FIG. 13. At pH 7.4, net charge of albumin is −18, and that of HSA800 and coHSA800 was more negatively charged due to tetrasulfonated dye conjugation. QDs have the highest extinction coefficient at first absorption peak of 775 nm compared to any other organic fluorophores. Quantum yield of CW800 and HSA800 was same as that of QD in PBS, and rather higher in FBS. QDs had the highest fluorescence yield (FIG. 13A), however, HSA800 had the highest total fluorescence per molecule (FIG. 13B).

### Intraoperative Near-Infrared Fluorescent Sentinel Lymph Node Mapping

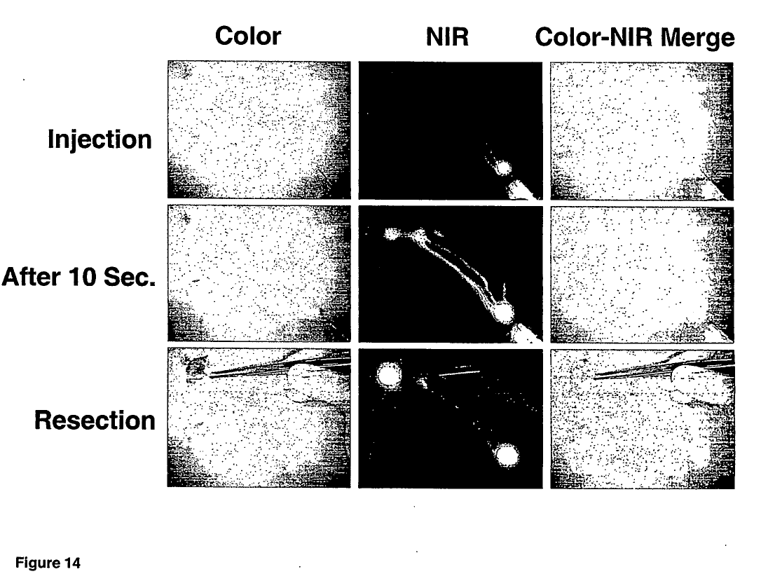

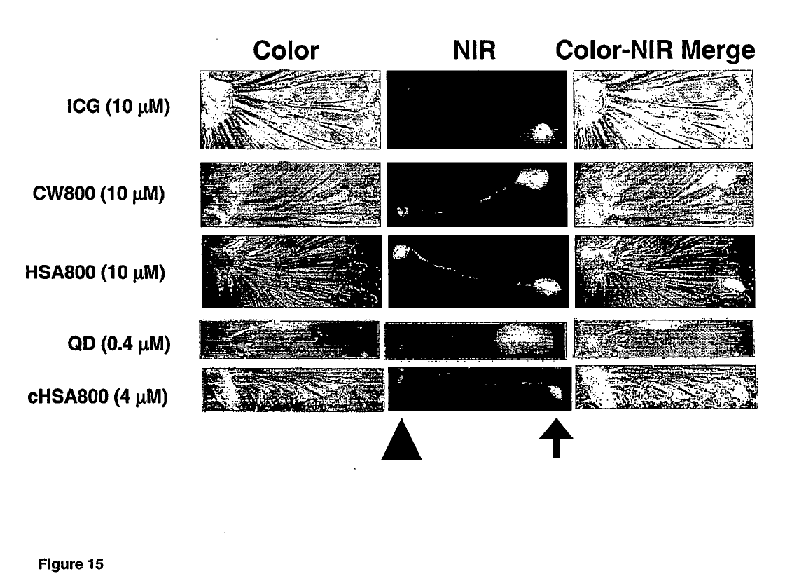

In order to verify the availability of those contrast agents in vivo, we operated sentinel lymph node (SLN) mapping to the pig. As shown in FIG. 14, HSA800 demonstrated ultra-fine lymphatic channels flowing to a single SLN immediately after the injection. Although the inguinal lymph nodes are located under the subdermal tissue, we could easily identify the SLN with NIR guidance. FIG. 15 shows the SLN mapping of the intestine with a family of 800 nm contrast agents. Compared to other organic agents, certain amount of HSA800 injected entered the lymphatic channel and stayed bright for more than 1 hour.

All publications and patents cited herein are hereby incorporated by reference in their entirety.

Those skilled in the art will recognize, or be able to ascertain using no more than routine experimentation, many equivalents to the specific embodiments of the invention described herein. Such equivalents are intended to be encompassed by the following claims

We claim:

1. An imaging agent comprising a serum albumin protein covalently conjugated to one or more infrared or near-infrared fluorescent substances.

2. An imaging agent comprising serum albumin protein that is admixed with one or more infrared or near-infrared fluorescent substances.

3. An imaging agent of claim 2, wherein the one or more infrared or near-infrared fluorescent substances are admixed with the serum albumin, thereby forming a non-covalent complex.

4. The imaging agent according to claim 1 or 2, wherein the imaging agent comprises a fluorescent substance having a structure of formula (I) or formula (II): 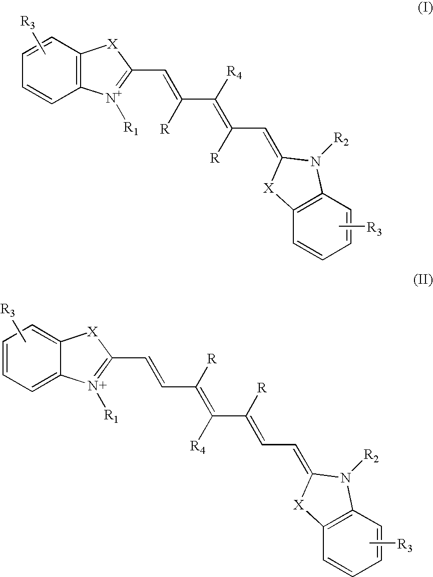
wherein, as valence and stability permit,
X represents C(R)₂, S, Se, O, or NR₅;
R represents H or lower alkyl, or two occurrences of R, taken together, form a ring together with the carbon atoms through which they are connected;
R₁ and R₂ represent, independently, substituted or unsubstituted lower alkyl, lower alkenyl, cycloalkyl, cycloalkylalkyl, aryl, or aralkyl, e.g., optionally substituted by sulfate, phosphate, sulfonate, phosphonate, halogen, hydroxyl, amino, cyano, nitro, carboxylic acid, amide, etc., or a pharmaceutically acceptable salt thereof;
R₃ represents, independently for each occurrence, one or more substituents to the ring to which it is attached, such as a fused ring (e.g., a benzo ring), sulfate, phosphate, sulfonate, phosphonate, halogen, lower alkyl, hydroxyl, amino, cyano, nitro, carboxylic acid, amide, etc., or a pharmaceutically acceptable salt thereof;
R₄ represents H, halogen, or a substituted or unsubstituted ether or thioether of phenol or thiophenol; and
R₅ represents, independently for each occurrence, substituted or unsubstituted lower alkyl, cycloalkyl, cycloalkylalkyl, aryl, or aralkyl, e.g., optionally substituted by sulfate, phosphate, sulfonate, phosphonate, halogen, hydroxyl, amino, cyano, nitro, carboxylic acid, amide, etc., or a pharmaceutically acceptable salt thereof.

5. A pharmaceutical preparation comprising an imaging agent of claim 1 or 2 and a pharmaceutically acceptable excipient.

6. The imaging agent according to claim 1 or 2, wherein the imaging agent comprises a fluorescent substance selected from indocyanine green, IRDye78, IRDye80, IRDye38, IRDye40, IRDye41, IRDye700, IRDye800, IRDye800CW, Cy7, IR-786, DRAQ5NO, or an analog thereof.

7. An imaging agent of claim 1 or 2, wherein said serum albumin protein is a human serum albumin protein.

8. An imaging agent of claim 1 or 2, wherein said serum albumin protein is colloidal serum albumin protein.

9. An imaging agent of claim 8, wherein the colloidal serum albumin protein is nanocolloidal serum albumin protein.

10. An imaging agent of claim 1 or 2, wherein the fluorescent substance is IRDye78, IRDye800CW, indocyanine green, or an analog thereof.

11. The imaging agent according to claim 1 or 2, wherein the imaging agent comprises a fluorescent substance having a structure of the formula (I) or formula (II): 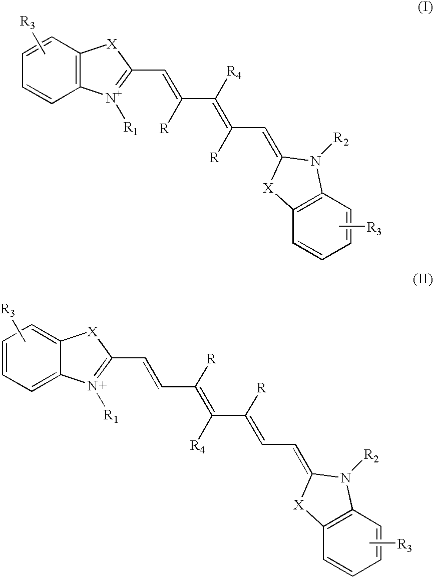
wherein, as valence and stability permit,
X represents C(R)₂, S, Se, O, or NR₅;
R represents H or lower alkyl, or two occurrences of R, taken together, form a ring together with the carbon atoms through which they are connected;
R₁ and R₂ represent, independently, substituted or unsubstituted lower alkyl, lower alkenyl, cycloalkyl, cycloalkylalkyl, aryl, or aralkyl, e.g., optionally substituted by sulfate, phosphate, sulfonate, phosphonate, halogen, hydroxyl, amino, cyano, nitro, carboxylic acid, amide, etc., or a pharmaceutically acceptable salt thereof;
R₃ represents, independently for each occurrence, one or more substituents to the ring to which it is attached, such as a fused ring (e.g., a benzo ring), sulfate, phosphate, sulfonate, phosphonate, halogen, lower alkyl, hydroxyl, amino, cyano, nitro, carboxylic acid, amide, etc., or a pharmaceutically acceptable salt thereof;
R₄ represents H, halogen, or a substituted or unsubstituted ether or thioether of phenol or thiophenol; and
R₅ represents, independently for each occurrence, substituted or unsubstituted lower alkyl, cycloalkyl, cycloalkylalkyl, aryl, or aralkyl, e.g., optionally substituted by sulfate, phosphate, sulfonate, phosphonate, halogen, hydroxyl, amino, cyano, nitro, carboxylic acid, amide, etc., or a pharmaceutically acceptable salt thereof.

12. A pharmaceutical preparation comprising an imaging agent of claim 10 and a pharmaceutically acceptable excipient.

13. The imaging agent according to claim 11, wherein the imaging agent comprises a fluorescent substance selected from indocyanine green, IRDye78, IRDye80, IRDye38, IRDye40, IRDye41, IRDye700, IRDye800, IRDye800CW, Cy7, IR-786, DRAQ5NO, or an analog thereof.

14. An imaging agent of claim 11, wherein said serum albumin protein is a human serum albumin protein.

15. An imaging agent of claim 11, wherein said serum albumin protein is nanocolloidal serum albumin protein.

16. An imaging agent of claim 11, wherein the fluorescent substance is selected from IRDye78, IRDye800CW, indocyanine green or an analog thereof.

17. A method of imaging either the lymphatic or circulatory system of an animal or any portion thereof, comprising
(a) introducing an imaging agent of claim 1, 2, 14, or 15 into the animal;
(b) exposing the animal or portion thereof to light; and
(c) detecting an emission wavelength of the imaging agent.

18. A method for of imaging the lymphatic system of an animal or any portion thereof, comprising
(a) introducing a fluorophore into the animal;
(b) exposing the animal or portion thereof to light; and
(c) detecting an emission wavelength of the imaging agent.

19. A method of claim 17 or 18, wherein the fluorophore is selected from indocyanine green, IRDye78, IRDye80, IRDye38, IRDye40, IRDye41, IRDye700, IRDye800, IRDye800CW, Cy7, IR-786, DRAQ5NO, or an analog thereof.

20. The method of claim 17 or 18, wherein said light comprises an excitation wavelength of the fluorescent substance.

21. The method of claim 17 or 18, wherein detecting an emission wavelength includes generating an image from light detected in the near-infrared or infrared wavelength region.

22. The method of claim 17 or 18, comprising generating a color video image of an area surrounding the injection site and an image in the near-infrared or infrared wavelength region.

23. The method of claim 17 or 18, wherein detecting an emission wavelength includes imaging a site of the animal through the skin.

24. The method of claim 17 or 18, wherein detecting an emission wavelength includes imaging a site of the animal that is exposed by surgery or another medical procedure.

25. The method of claim 17 or 18, wherein detecting an emission wavelength includes imaging at least a portion of an eye of the animal.
